(19) United States
(12) Patent Application Publication
(10) Pub. No.: US 2026/0311117 A1
(43) Pub. Date: Oct. 8, 2026

(54) SYSTEMS, MEDIA, AND METHODS FOR AUTOMATED PLANOGRAM GENERATION

(71) Applicant: 3M INNOVATIVE PROPERTIES COMPANY, St. Paul, MN (US)

(72) Inventors: Sean T. Kalafut, Minneapolis, MN (US); Brian E. Brooks, St. Paul, MN (US); Frederick J. Arsenault, Stillwater, MN (US); Peter G. Klink, St. Paul, MN (US); Tyler W. Olson, Esko, MN (US); Peter O. N. Olson, Andover, MN (US); Wilmina M. Marget, Rosemount, MN (US); Elliot Khazon, St. Paul, MN (US); Brendan P. Miller, St. Paul, MN (US)

(21) Appl. No.: 19/481,342

(22) PCT Filed: Apr. 25, 2024
(86) PCT No.: PCT/IB2024/054058

§ 371 Date: Nov. 4, 2025

Related U.S. Application Data
(60) Provisional application No. 63/467,721, filed on May 19, 2023.

(51) Int. Cl. G06Q 10/087

(52) U.S. Cl. CPC G06Q 10/08724

(57) ABSTRACT

A method includes generating a plurality of candidate planograms based upon a plurality of current design rules and outputting a graphical representation of each of a subset comprising a plurality of the candidate planograms. The method also includes receiving categorization input to place each candidate planogram in the subset within one of a plurality of categories, and creating and outputting candidate rules based upon at least one of the categories. The method further includes receiving rule input specifying a plurality of candidate design rules to retain. The method additionally includes outputting an updated subset of the candidate planograms based upon the received design rule input, and outputting a graphical representation of at least one finalized planogram.

### BACKGROUND

Retailers spend vast sums of money and employee time to understand and optimize the assortments of products across their stores. One consideration has been determining which products should be offered. Another consideration, when changing the amount of space allocated to each product in conjunction or without changing the set of products offered, includes how the physical layout of products should change within a store. Enormous teams of people with large budgets were often dedicated to each of these questions and others like them. Historically, this process was done manually by individuals and was error-prone and time-consuming.

This work has been further encumbered by the general diversification of products among a retailer's stores. Customers in different markets are often offered different products presented through different planograms to better align with their purchase preferences. When a retailer seeks to make a specific planogram change across multiple existing planograms and stores, the time required to design new planograms with that change grows with the number of unique existing planograms. For a retailer with thousands of stores or more, it is possible to have hundreds, thousands, or more, of different planograms for a single product category across all stores. In such a product category for the retailer, if one planogram change is desired across several hundred different planograms and the planogram design process takes even a few minutes per planogram, one person would need to work for several days just to design new planograms. Thus, the generation of new planograms based on desired planogram or assortment changes can be very cumbersome and time consuming. This, in turn, can frequently delay the implementation of new planograms and assortments in stores.

### SUMMARY

In an embodiment, at least one non-transitory computer-readable medium encoded with instructions that, when executed, configure at least one processor for generating a plurality of candidate planograms based upon a plurality of current design rules and outputting a graphical representation of each of a subset comprising a plurality of the candidate planograms. The non-transitory computer-readable medium also includes instructions for receiving categorization input to place each candidate planogram in the subset within one of a plurality of categories, and creating and outputting candidate rules based upon at least one of the categories. The non-transitory computer-readable medium also includes instructions for receiving rule input specifying a plurality of candidate design rules to retain. The non-transitory computer-readable medium also includes instructions for outputting an updated subset of the candidate planograms based upon the received design rule input, and outputting a graphical representation of at least one finalized planogram.

In another embodiment, a computing device comprises at least one memory and at least one processor coupled to at least one of the at least one computer memory, the at least one processor being configured to perform operations to generate a plurality of candidate planograms based upon a plurality of current design rules and output a graphical representation of each of a subset comprising a plurality of the candidate planograms. The processor is further configured to receive categorization input to place each candidate planogram in the subset within one of a plurality of categories and create and outputting candidate rules based upon at least one of the categories. The processor is also configured to receive rule input specifying a plurality of candidate design rules to retain and output an updated subset of the candidate planograms based upon the received design rule input. The processor is also further configured to output a graphical representation of at least one finalized planogram.

In yet another embodiment, a method includes generating a plurality of candidate planograms based upon a plurality of current design rules and outputting a graphical representation of each of a subset comprising a plurality of the candidate planograms. The method also includes receiving categorization input to place each candidate planogram in the subset within one of a plurality of categories, and creating and outputting candidate rules based upon at least one of the categories. The method further includes receiving rule input specifying a plurality of candidate design rules to retain. The method additionally includes outputting an updated subset of the candidate planograms based upon the received design rule input, and outputting a graphical representation of at least one finalized planogram.

### BRIEF DESCRIPTION OF THE DRAWINGS

FIG. 1 is a flow diagram schematically illustrating a method for planogram generation in accordance with embodiments herein;

FIG. 2 is a diagram schematically illustrating an original planogram before the green item is removed and a facing of the orange item is added in accordance with embodiments herein;

FIG. 3 is a diagram schematically illustrating multiple candidate planograms for a set of 5 products that must be placed on one shelf in accordance with embodiments herein;

FIG. 4 is a diagram schematically illustrating two possible planograms for a hypothetical product A that must have two facings in accordance with embodiments herein;

FIG. 5 is a diagram schematically illustrating examples of coordinate decompositions for planograms of different geometries in accordance with embodiments herein;

FIG. 6 is a diagram schematically illustrating user-identified sets of products in a poorly rated candidate planogram that are highlighted in dashed-line boxes in accordance with embodiments herein;

FIG. 7 is a diagram schematically illustrating two candidate planograms that are compared to derive new planogram design themes in accordance with embodiments herein;

FIG. 8 is a diagram schematically illustrating candidate planograms being presented to an expert in accordance with embodiments herein; and

FIG. 9 is a block diagram of computing hardware utilized to implement various embodiments herein.

### DETAILED DESCRIPTION

In embodiments, a planogram represents a physical structure regarding (i) products being located on different levels of the physical structure, (ii) the amount of inventory space visible to customers, and (iii) the arrangement of those products relative to each other. Planogramming can also include broader concerns such as overall product assortment, supply chain, and the like. For many retailers, the timeline of changing product offerings through locations, assortments and planograms may include a budget of one to several weeks to design new planograms to accommodate the desired changes.

The automated planogram generation systems, media, and methods described herein may be utilized to reduce the time needed and complexity of designing new planograms. Rules may be embedded in logic so that the execution of the processes described herein take minutes or hours rather than days or weeks, for example. This tremendous increase in speed/efficiency in turn enables faster implementation of recommended changes from optimization systems, and faster and more accurate measurements of customer response to changes. Thus, the time commitment from retailers and product manufacturers can be better spent focusing on meeting customer needs and desires through frequent changes (e.g., quarterly, monthly, and the like), instead of annual changes to product offerings. For example, by employing the automated planogram generation disclosure described here, large teams of retailer employees working on planogram design can instead focus on more substantial and groundbreaking endeavors that are more valuable to the retailer, such as improving customer experiences through differentiated planogram design.

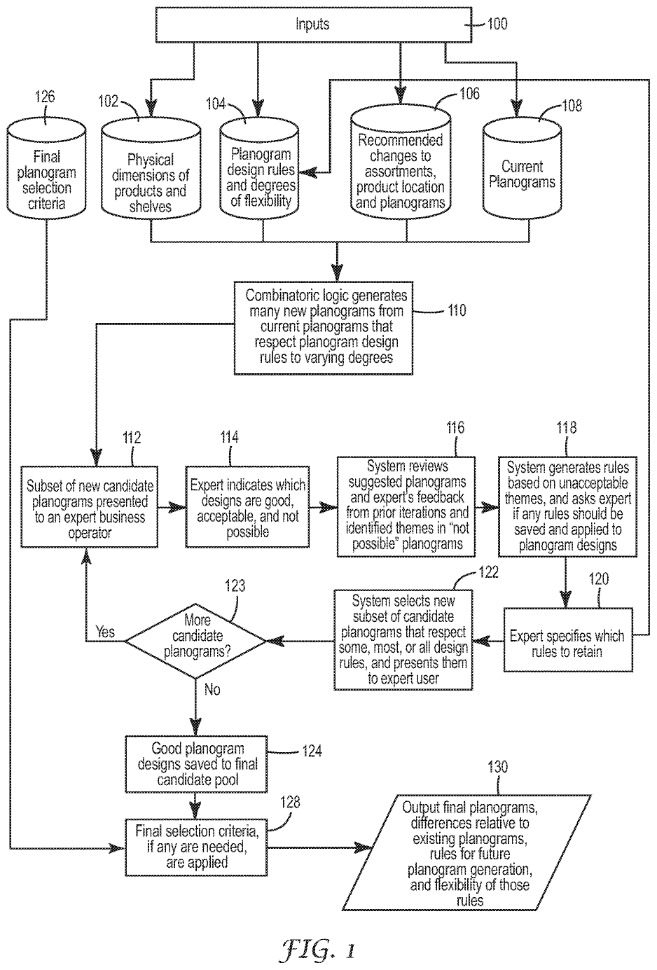

Referring now to FIG. 1, a flowchart for automatically generating retail planograms based on desired planogram features, store specific shelf layouts, and retailer rules and constraints according to one embodiment is depicted. At block 100, various types of inputs may be received, which are delineated further with respect to blocks 102-108. At block 102, the physical dimensions of products and/or shelves may be received as input. In this embodiment, the amount of customer-visible inventory space allocated to each product can be “facings” on a shelf, hanging pegs on a board, or some other unit. This may include, for example, the physical dimensions of all products within a category and the structures where products are situated-shelves, hanging pegs, display cases, or other structures. A category may include all products within any type of logical grouping utilized by a retailer or other entity, such as, by way of non-limiting example, fasteners in one category, adhesives in another category, decorations in yet another category, and the like.

At block 104, planogram design rules and associated degrees of flexibility may also be received as input. This may include, for example, rules that constrain the physical layout of products within a category and optionally which rules if any can be violated. By way of non-limiting example, a retailer may want, under a first rule, for nails to be in the category of fasteners but nevertheless allow a degree of flexibility as to how rigidly this must be enforced. Continuing with this example, the flexible nature of the first rule may allow for it to be ignored if a less-flexible second rule would be violated by adhering to this first rule. Put another way, while the physical layout of products in a specific location at a store may be constrained by rules developed by the retailer and product manufacturers, these rules may be insufficient to specify (i) how new products should be added to a planogram at a store and/or (ii) how to accommodate greater shelf space for specific products in an existing planogram. Examples of these rules can be that products with similarly-styled packaging (color, shape, etc.) should be placed on the same shelf or row of hanging pegs, products of the same family but different pack sizes should be placed on adjacent shelves, or products with very different prices should not be adjacent neighbors. The degree to which new planograms must adhere to these rules is also an under-constrained problem in some embodiments.

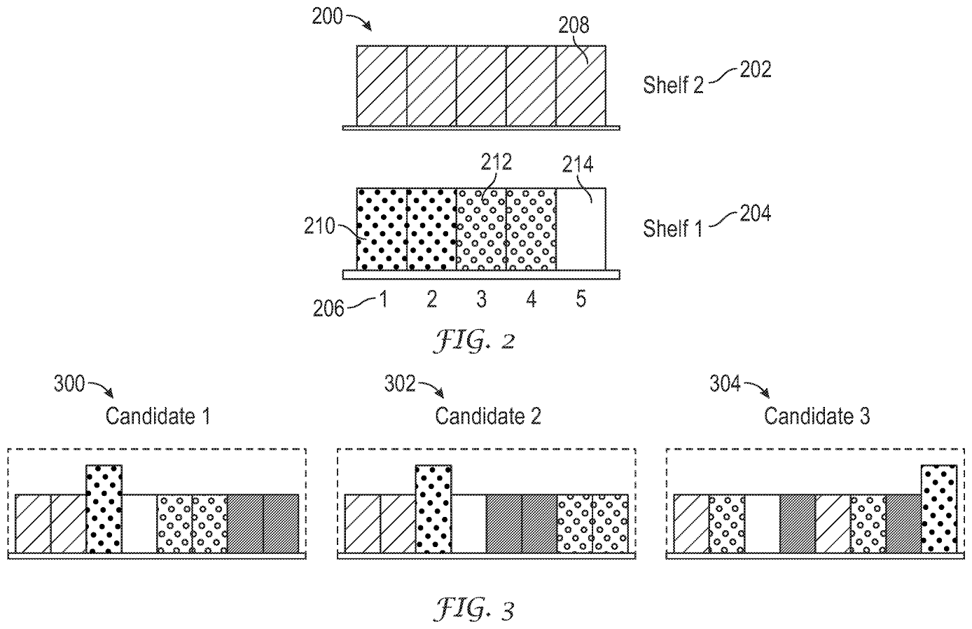

Planogram design rules may also be derived from historical sales data or analyses of those data to compliment rules that are provided as input by an expert user. In some embodiments, the historical data for a given store may be upon, by way of non-limiting example, capacity data and/or store velocity data (e.g., item/inventory consumption rate or the like). Consider for example substitution estimates shown in Table 1 below, between four products offered in one planogram depicted in FIG. 2. Based on the substitution estimates the green item (position 5 on shelf 1) will be removed, and a facing will be added to the orange item, but in principle this facing can be added to either shelf and at any position. However, the substitution estimates indicate that customers who buy the orange item can substitute to the red item. Therefore, the additional facing of the orange item should be added in close proximity to facings of the red item. This can be represented as a rule that requires the additional facing of the orange item be located on the same shelf and as close as possible in horizontal position to facings of the red item. This mechanism to identify planogram design rules may be toggled on or off by an expert user, and can be extended to use other analysis estimates such as multi-product purchase patterns. Table 1 depicts substitution estimates between products in one planogram across multiple stores, where ‘Y’ indicates substitution is observed and ‘N’ indicates that substitution is not observed.

TABLE 1

| Removed item color | Green item | Red item | Blue item | Orange item |
|---|---|---|---|---|
| Green | N/A | Y | Y | Y |
| Red | N | N/A | Y | Y |
| Blue | N | Y | N/A | Y |
| Orange | N | Y | N | N/A |

At block 106, another input received may specify those assortments, planograms, in-store product locations, stores, and/or product categories where these changes should be made. Input received may specify recommendations regarding assortments, planograms, in-store product locations, stores, and/or product categories where these changes should be made. If the input recommendations regard new planograms, then in some embodiments the possible candidate planograms are derived from the recommended planograms and not the planograms currently in stores.

At block 108, current planograms may be received as input, which may include the current planograms at stores and product categories where changes are recommended. At block 110, based upon one or more of the inputs at blocks 102-108, combinatoric logic may be utilized to generate new planograms from current planograms that respect planogram design rules to varying degrees. Thus, the inputs from blocks 102-108 in some embodiments quickly may converge to (i) one or more new planograms (such as at each store) that integrate the desired changes with the existing physical structure, (ii) a more complete set of rules that will further expedite planogram generation in the future, (iii) the differences between the new planogram and the current planogram, and/or (iv) an ordinal rank of the degree of constraint on planogram design imposed by each rule. For each input rule defined by the user, optional changes for flexibility and selection criteria may be implemented once within the generation system and persist for a specified duration or indefinitely. Given these rules and flexibility specifications, a large set of new candidate planograms that respect some, most or all provided rules may be generated.

The primary degrees of freedom that enable multiple planograms to be created for a given store may include the shelves where each product is placed and the absolute location along the one-dimensional (1D) horizontal dimension created by the shelf where each product is placed. If a finite set of products are identified and at least one product can be placed on multiple different shelves or multiple locations on a single shelf, then multiple unique planograms may be possible. Consider a non-limiting example in which five products must be placed on the same shelf, and the number of facings for each product is sufficiently specified that the shelf is full. Three out of the thousands of possible planogram candidates are shown in FIG. 3. The number of possible candidate planograms is very large because a new planogram is created each time one facing of one product exchanges positions with one facing of a different product. With no software assistance an expert user responsible for drawing the new planogram would need to develop their own constraints using intuition and knowledge of existing planogram design preferences and rules to reduce from thousands of possible candidates to a singular planogram. There are likely many candidate planograms the expert would not consider because there are so many, even if they are viable candidates. Using embodiments herein, the expert user can instead rely on the system to programmatically identify and deliver small sets of diverse candidate planograms that represent a broad range of candidate new planograms. If the expert user ultimately selects the same planogram that they would have chosen without using this system, then at least they can be more confident that a more diverse set of planograms were considered before making the final selection.

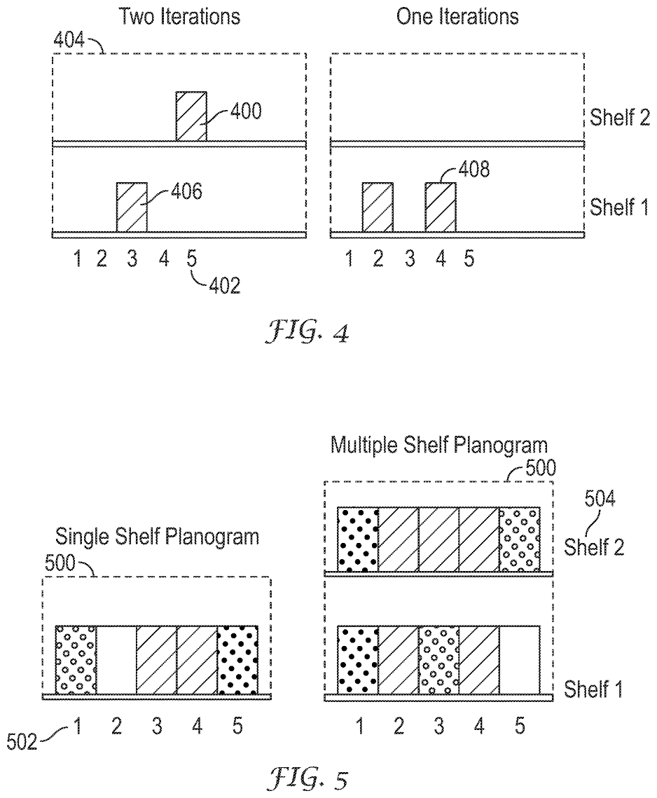

The planogram generation logic may begin by identifying the set of shelves where all products can be placed, and then for each product randomly selects the shelf number, number of the total facings to allocate and position 402 of each facing. FIG. 4 depicts an example in which a product A 400 can be placed on shelf 1 or shelf 2 and could be split between both shelves, which must have 2 total facings, and which can be placed in any position 402 on either shelf. One random selection process may require two iterations. A first iteration 404 could allocate 1 facing to shelf 2 at position 5. A second iteration 406 could allocate 1 facing to shelf 1 at position 3. Another random selection process may require one iteration 408, thus a first iteration to allocate 2 facings to shelf 1 at positions 2 and 4. This random selection process may repeat many times until each candidate planogram is filled with the requisite products, and many different candidate planograms are produced. Any design rules that must always be enforced (for example, product A 400 must have 2 facings) are applied during the random selection process, while design rules that are flexible (product A could be split between both shelves) may be randomly toggled on and off. Stratification may be used here to increase the diversity of candidate planograms with respect to which rules are enforced and are not enforced.

Returning to FIG. 1, at block 112 an iterative process may begin, in which a subset of new candidate planograms may be presented to an expert who may be asked to rate/group the candidate planograms as further discussed with respect to FIG. 2. Any suitable type of rating system may be utilized, such as textually-descriptive (e.g., rating candidate planograms as “good”, “acceptable”, and “not possible” or “not acceptable”, and the like), numerical (e.g., a rating scale where 10=best, 1=worst, wherein ratings of 7-10 are to be included as final candidates, 4-6 are potential choices subject to possible relaxation of rules, and 1-3 are not possible), visual/graphical (e.g., clustering of candidates), and/or any other type of categorization may be utilized. In some embodiments, an expert may be any suitable user or operator capable of making determinations regarding planogram selections, rules specifications, and the like.

Many differentiated candidate planograms may be generated quickly, but the expert user(s) should not be burdened with the task of reviewing most of them to identify final planogram designs. Instead, a subset of a few candidate planograms, such as between 7 and 15 (arbitrary for the first round), may be selected and presented to the expert user for review. There are many methods that can be used to select these candidate planograms, and several are described here as non-limiting examples.

One example may start by selecting one candidate planogram, called planogram H, at random to use as a standard against which all other candidate planograms are compared. For each other candidate planogram the absolute value difference in shelf and horizontal position location for each product may be calculated relative to planogram H. In addition, for each other candidate planogram there may be a calculation for a score equal to the number of flexible rules that are met (score increases by D), and the number of flexible rules that are not met (score decreases by-E, where E!=D and E>0) relative to planogram H. The candidate planograms may be clustered based on the absolute value differences in product positions, and the difference in flexible rules that are or are not enforced. From each cluster, one candidate planogram may be selected at random, and the standard (reference) planogram H and between 7 and 14 additional candidate planograms may be presented to the expert user for evaluation.

Returning to FIG. 1, at block 114, the expert may be presented with an interface to rate/group the candidate planograms as further discussed with respect to FIG. 2 (e.g., rating candidate planograms as “good”, “acceptable”, “not possible”, and the like). At block 116, the system may collect the expert's feedback, reviewing suggested planograms and the expert's feedback from prior iterations and identified themes in “not possible” planograms. In some embodiments, prior iterations from other experts and/or planogram review sessions may be utilized. “Good” planograms may be saved to a pool of final candidates.

Every planogram evaluated in by the expert user can provide value that expedites the planogram drawing process, even for planograms evaluated as average, good or superior, or at or above the average or median value on a numeric rating scale. planogram design themes that may be avoided can be extracted from planogram candidates that the expert identifies as poor, and design themes that may be desired can be extracted for planogram candidates with a satisfactory or higher evaluation on any rating scale. Details on how themes are extracted are discussed and illustrated herein.

Planogram design themes can be decomposed into several elementary components from which any complex theme can be built. In general, the elementary components may combine to capture where product facings are located and what product facings are adjacent to them (in some cases this information may be redundant). FIG. 5 depicts how the decomposition can vary based on the physical geometry of the shelf or shelves where products are placed to better represent the available degrees of freedom. By way of non-limiting example, in a planogram with one shelf (horizontal and rectangular, circular and flat, and the like), the decomposition can be the absolute 1D position 502 of each product facing on the shelf, or it can be the absolute 1D position 502 of a single facing of one product combined with the relative position 502 of every other product facing with respect to the absolute 1D position 502 of the single facing of one product. In a planogram 500 where products are arranged on the perimeter of a polygon, such as a circle or triangle, that is attached to a rotating wheel, the decomposition can be which product facings are immediate neighbors to each single facing of one product (effectively a relative position 502 based on nearest neighbors). Such planograms 500 may be utilized in areas where floor space is limited but few constraints exist in the vertical direction, like on the desk adjacent to a paint mixing machine in stores of a home improvement retailer. A planogram 500 with multiple horizontal shelves that are stacked vertically can be treated as multiple instances of what was already described for a planogram 500 with a single horizontal shelf combined with a representation of vertical position 504 like a shelf number or absolute vertical position. A planogram 500 with multiple horizontal shelves that are stacked vertically can be decomposed into the absolute horizontal position 502 and absolute vertical position 504 of each product facing on each shelf, or the absolute horizontal position 502 of each product facing on each shelf combined with the ordinal shelf number value of each shelf that indicates where each shelf is located relative to the bottom shelf (closest to the floor). The expert user may select a decomposition as part of providing initial planogram design rules and constraints as input, and can change it later at will.

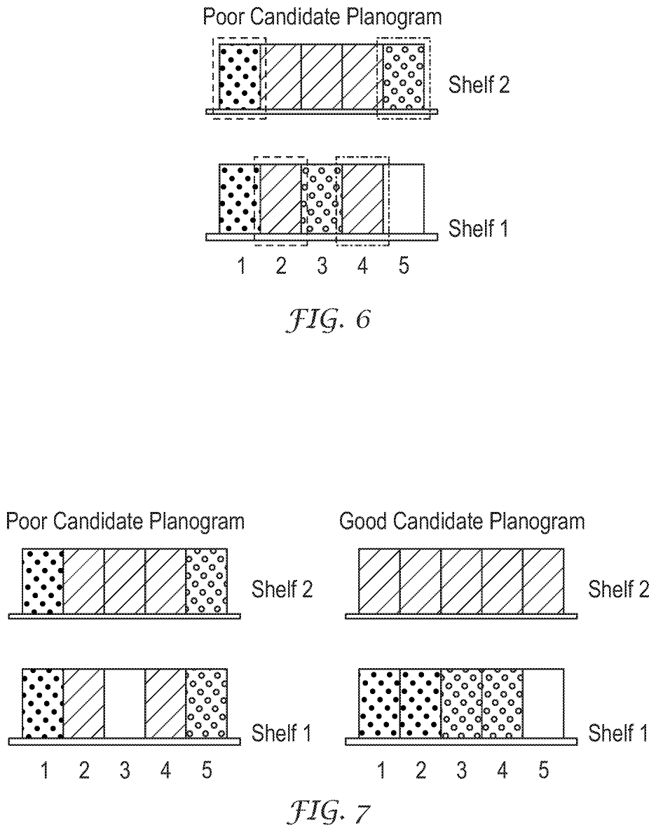

Given the selected coordinate decomposition and a finite set of candidate planograms that have been rated by an expert user, planogram design themes are programmatically extracted from the rated planograms using comparisons and additional quick feedback from an expert user. As depicted in FIG. 6, when no good or highly rated candidate planograms have been identified, embodiments described herein may solicit feedback from the expert user to identify a few sets of products in poorly rated candidate planograms where they see a problem. Using the user feedback the system can quickly generate themes based on relative locations of highlighted product facings and the number of unique products highlighted in Table 2. More specifically, Table 2 depicts new planogram design themes based on user feedback.

TABLE 2

| # of highlighted product | | |
|---|---|---|
| facings, # of unique products | One or multiple shelves | New planogram design theme |
| 2, 1 | One shelf | Bring facings into adjacent |
| | | positions |
| 2, 2 | Multiple shelves | Swap facing positions |
| 2, 2 | One shelf | Push facings apart |
| 3, 3 | Multiple shelves | Bring facings onto same shelf |
| 4, 1 | Multiple shelves | Align facings in a vertical |
| | | column across shelves |

Once satisfactory/good/highly rated candidate planograms are identified by an expert user, embodiments herein may rely less on an expert user highlighting specific products and facings and rely more on direct comparisons between poor/low rated candidate planograms and good/high rated candidate planograms. Comparing the locations of specific product facings between candidate planograms can generate many design themes, and user input can further constrain what themes are produced. As an example depicted in FIG. 7, one good candidate planogram may place all facings of one product on the same shelf, while a poor candidate planogram may spread the same facings across two shelves. Embodiments herein can then identify this difference as one product having facings across multiple absolute vertical positions or shelf numbers. When the themes are presented to users they can be sorted so that, for example, the themes presented first are those that affect the largest number of facings.

Returning to FIG. 1, at block 118, while the “good” planograms may have value in terms of being candidates for selectable planograms, the “not possible” planograms have important value as well. Specifically, rules may be generated based on planogram themes that are not possible or are otherwise unacceptable. The expert may be asked in an interface whether any rules should be saved and applied to planogram designs. For example, the expert may be prompted: “It appears you have a rule of XYZ, is that a rule you want to make explicit?” At block 120, the expert may specify which rules to retain. Rules selected by the expert may also be added to the set of design rules provided as input in some embodiments. By way of non-limiting example, a rule regarding a minimum height between shelves may be utilized regarding accommodating the height of a certain good.

Once planogram design themes, both desirable and undesirable, are identified, those themes must be translated in some embodiments into rules that can be integrated into the generation or selection of new candidate planograms. The distinction in such embodiments between design themes and design rules is that an expert user identifies design constraints by inspecting a list of human readable themes, while the programmatic implementation of those design constraints must be quantitative to generate new candidate planograms that may respect those constraints. Example themes that were described previously and their corresponding design rules are listed in Table 3. Note that these themes are linked to specific candidate planograms, and those links are combined with the themes when rules are created. Table 3 depicts planogram design themes and corresponding design rules below.

TABLE 3

| Candidate planogram ID | New planogram design theme | New planogram design rule |
|---|---|---|
| P1 | Bring facings into adjacent | Minimize the sum of absolute |
| | positions | differences in horizontal |
| | | positions for all selected facings |
| P2 | Swap facing positions | Set new position of facing 1 to |
| | | original position of facing 2; set |
| | | new position of facing 2 to |
| | | original position of facing 1 |
| P3 | Push facings apart | Maximize the sum of absolute |
| | | differences in horizontal |
| | | positions for all selected facings |
| P5 | Align facings in a vertical | Identify one column with largest |
| | column across shelves | number of existing selected |
| | | facings |
| | | Move off-column selected |
| | | facings into selected column |
| | | without changing the shelf |
| | | number, and relocate the |
| | | displaced facings to the original |
| | | positions of the off-column |
| | | selected facings |

At block 122, a new subset of candidate planograms that respect some, most, or all design rules, may be selected and presented to the expert user. Planograms that only respect some or most of the design rules may be presented to the expert user because the design rules may still be an approximation of the ideal planograms that likely have multiple unique physical layouts. Some design rules may not be needed or become redundant if other rules are respected, and it may be difficult to know this without evaluations from an expert user. If no new planogram can be generated, then the expert may be informed as to which rules are over-constraining the generation process. The expert may be asked which rules can be relaxed to enable the generation of a new planogram for every store. The expert may then specify which rules can be relaxed, and the system may then identify the smallest subset of rules to relax. In this embodiment, a new planogram can then be generated for every store and the number of rules that are respected can be maximized.

At block 123, if there are more planogram candidates (condition: YES), then the flowchart may iteratively return to block 112 to process the additional planogram candidates. Otherwise, if there are no additional candidate planograms (condition: NO), then at block 124, the iterative process may conclude and the planogram designs categorized as “good” may be saved to a final candidate pool. Planograms identified as “good” may also be evaluated using a different system and have an alternate ordinal rank such as “excellent” or “above average”, or a numeric rating system and have a high numeric score.

At block 126, final planogram selection criteria may be utilized as an additional input. For example, if multiple new planograms are possible at any one store and product category, multiple criteria can be explored to select a new planogram. Example criteria may include minimizing/maximizing the difference between the new and current planogram, minimizing/maximizing the number of optional rules that are violated, and minimizing/maximizing the similarity of planogram changes across all affected stores.

At block 128, final selection criteria, if any are needed, may be applied. For example, once each store and product category has at least one approved (“good”) planogram, the iterative process may stop and the final selection criteria may be applied if any store and product category has multiple approved new planograms. For example, the expert user may want to test different planograms within the set of stores that fall in specific ranges of values of store attributes, such as the percentage of store customers that are professional contractors, or the fraction of store customers that live in rented housing. To setup such a test the stores may be clustered based on the pertinent store attributes, and to each cluster of stores that meet the expert user's selection requirements a different planogram may be assigned. In other embodiments, stores may be clustered based upon known customer attribute data (e.g., demographics, income, frequency of purchases, item preferences, and the like) for each of the clustered stores. This example using store attributes (geography, presence of competitor stores, and the like) can be extended to other data driven metrics including historical sales of specific products and substitution estimates between products. As discussed herein with respect to block 122, in some embodiments, if no candidate planograms remain after the final selection criteria, then the system may inform the expert which rules are over-constraining the generation process and may ask which rules can be relaxed to enable the generation of a new planogram for every store. The expert may then specify which rules can be relaxed, and the system may then identify the smallest subset of rules to relax. In some embodiments, a new planogram can then be generated for every store and the number of rules that are respected can be maximized. At block 130, outputs may include final planograms, differences relative to existing planograms, rules for future planogram generation, and flexibility of those rules.

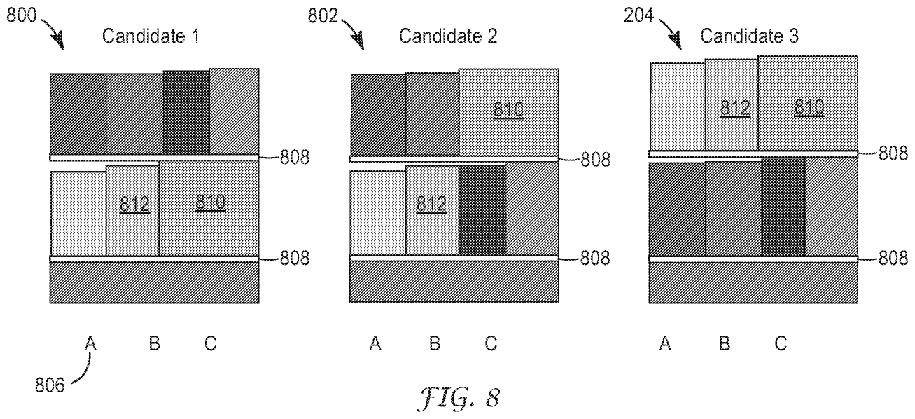

Referring now to FIG. 8, a diagram schematically illustrating candidate planograms being presented to an expert according to one embodiment is depicted. By way of non-limiting example, a set of candidate planograms may include a first planogram 800 (e.g., candidate 1), a second planogram 802 (e.g., candidate 2), and a third planogram 804 (e.g., candidate 3). Each candidate planogram may be evaluated and assigned to a grouping such as good (e.g., “a”), acceptable (e.g., “b”), not possible (e.g., “c”), and the like. The rules that constrain the physical layout of products may be subject to, by way of non-limiting example, the height of shelves 808. For example, a product may be too tall to fit on the bottom shelf 808 and may need to be located on the top shelf 808 instead. Additionally, product location may be determined in relation to how products are co-located, such as requiring two products to be located next to each other, or in another example, prohibiting products from being located next to each other. As depicted in the first candidate planogram 800, a first product 810 is located on a bottom shelf of the first planogram 800 next to a second product 812, while in the second candidate planogram 802 the first product 810 is located on a top shelf away from the second product 812. In the third candidate planogram 804, the first product 810 is located next to the second product 812 on the top shelf.

Changes recommended may be inclusive of planogram rules and specified at a level of granularity where some flexibility in final planogram design still exists. In one example, an assortment change may be specified at the level of replacing a single facing of product X with product Y. In another example, a planogram change may be specified at the level of placing facings of product D next to facings of product H on the same shelf. The vertical location of a given shelf 808 (lowest, middle, highest, and the like) may be specified, but may still be degrees of freedom in terms of the horizontal location and what other products are situated around the affected products. These degrees of freedom may be a burden to people involved in planogram design and implementing changes in stores, but a boon to the users of the systems, media, and methods described herein.

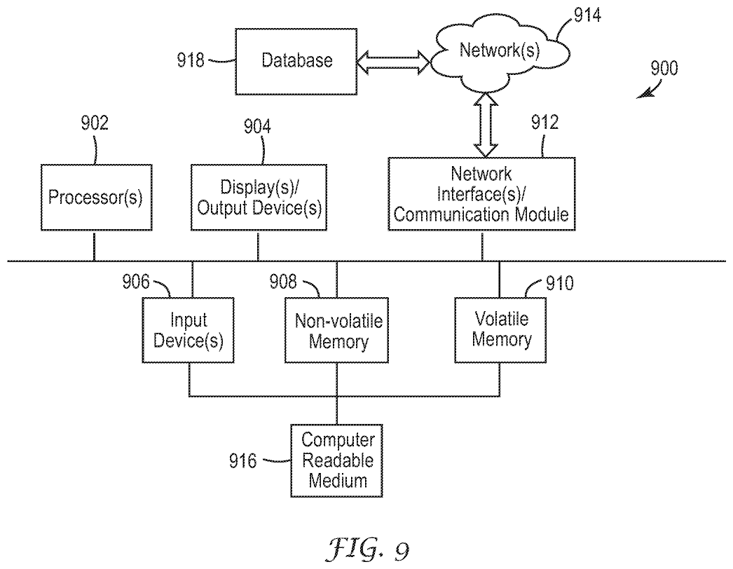

Referring now to FIG. 9, a block diagram illustrates computing hardware, such as an exemplary computing device 900, through which embodiments of the disclosure can be implemented. The computing device 900 described herein is but one example of a suitable computing device and does not suggest any limitation on the scope of any embodiments presented. Nothing illustrated or described with respect to the computing device 900 should be interpreted as being required or as creating any type of dependency with respect to any element or plurality of elements. In various embodiments, the computing device 900 may include, but need not be limited to, a desktop, laptop, server, client, tablet, smartphone, computing cloud or any other type of device that can utilize data. In an embodiment, the computing device 900 includes at least one processor 902 and memory comprising non-volatile memory 908 and/or volatile memory 910. The computing device 900 can include one or more displays, display hardware, and/or output devices 904 such as, for example, AR/VR/MR/XR hardware, monitors, speakers, headphones, projectors, wearable-displays, holographic displays, and/or printers. Output devices 904 may further include, for example, displays and/or speakers, devices that emit energy (radio, microwave, infrared, visible light, ultraviolet, x-ray and gamma ray), electronic output devices (Wi-Fi, radar, laser, etc.), audio (of any frequency), and the like.

The computing device 900 may further include one or more input devices 906 which can include, by way of example, any type of mouse, keyboard, disk/media drive, memory stick/thumb-drive, memory card, pen, touch-input device, biometric scanner, gaze and/or blink tracker, tracker, voice/auditory input device, motion-detector, camera, scale, and any device capable of measuring data such as motion data (e.g., an accelerometer, GPS, a magnetometer, a gyroscope, etc.), biometric data (e.g., blood pressure, pulse, heart rate, perspiration, temperature, voice, facial-recognition, motion/gesture tracking, gaze tracking, iris or other types of eye recognition, hand geometry, oxygen saturation, glucose level, fingerprint, DNA, dental records, weight, or any other suitable type of biometric data, etc.), video/still images, and audio (including human-audible and human-inaudible ultrasonic sound waves). Input devices 906 may include any type of device capable of receiving data, whether from another device, visual and/or audio data captured from the real world, object detection data, and the like. Input devices 906 may include cameras (with or without audio recording), such as digital and/or analog cameras, still cameras, video cameras, thermal imaging cameras, infrared cameras, cameras with a charge-couple display, night-vision cameras, three-dimensional cameras, webcams, audio recorders, and the like.

The computing device 900 typically includes non-volatile memory 908 (e.g., ROM, flash memory, etc.), volatile memory 910 (e.g., RAM, etc.), or a combination thereof. A network interface 912 can facilitate communications over a network 914 with other data source such as a database 918 via wires, a wide area network, a local area network, a personal area network, a cellular network, a satellite network, and the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks may include, but are not limited to, technologies such as LTE, WiMAX, UMTS, CDMA, and GSM. Network interface 912 can be communicatively coupled to any device capable of transmitting and/or receiving data via one or more network(s) 914. Accordingly, the network interface 912 can include a communication transceiver for sending and/or receiving any wired or wireless communication. For example, the network interface 912 may include an antenna, a modem, LAN port, Wi-Fi card, WiMax card, mobile communications hardware, near-field communication hardware, satellite communication hardware and/or any wired or wireless hardware for communicating with other networks and/or devices.

A computer-readable medium 916 comprises one or more plurality of computer readable mediums, each of which is non-transitory. A computer readable medium may reside, for example, within an input device 906, non-volatile memory 908, volatile memory 910, or any combination thereof. A readable storage medium can include tangible media that is able to store instructions associated with, or used by, a device or system. A computer readable medium, also referred to herein as a non-transitory computer readable medium, includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A non-transitory computer readable medium may also include, for example, a system or device that is of a magnetic, optical, semiconductor, or electronic type. A non-transitory computer readable medium excludes carrier waves and/or propagated signals taking any number of forms such as optical, electromagnetic, or combinations thereof.

The computing device 900 may include one or more network interfaces 912 to facilitate communication with one or more remote devices, which may include, for example, client and/or server devices. The network interface 912 may also be described as a communications module, as these terms may be used interchangeably. The database 918 is depicted as being accessible over the network 914 and may reside within a server, the cloud, or any other configuration to support being able to remotely access data and store data in the database 918.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. At least one non-transitory computer-readable medium encoded with instructions that, when executed, configure at least one processor for:
generating a plurality of candidate planograms based upon a plurality of current design rules;
outputting a graphical representation of each of a subset comprising a plurality of the candidate planograms;
receiving categorization input to place each candidate planogram in the subset within one of a plurality of categories;
creating and outputting candidate rules based upon at least one of the categories;
receiving rule input specifying a plurality of candidate design rules to retain;
outputting an updated subset of the candidate planograms based upon the received design rule input; and
outputting a graphical representation of at least one finalized planogram.

2. The at least one non-transitory computer-readable medium of claim 1 wherein generating a plurality of candidate planograms is further based upon one or more current planograms.

3. The at least one non-transitory computer-readable medium of claim 1 wherein generating a plurality of candidate planograms is further based upon at least one of:
rules that constrain physical layouts of products in a category;
physical dimensions of products in the category and structures where products are situated; and
recommended changes to assortments, planograms or in-store product locations and stores and product categories where these changes should be made.

4. The at least one non-transitory computer-readable medium of claim 3 wherein generating a plurality of candidate planograms is further based upon identification of which of the rules that can be violated.

5. The at least one non-transitory computer-readable medium of claim 1 encoded with further instructions for receiving final selection criteria, where the final selection criteria are utilized to determine the at least one finalized planogram.

6. The at least one non-transitory computer-readable medium of claim 1 encoded with further instructions for creating and outputting candidate rules based upon at least one of the categories further comprising an ordinal rank of the degree of constraint on planogram design imposed by each candidate rule.

7. The at least one non-transitory computer-readable medium of claim 1 encoded with further instructions for receiving rule input specifying a plurality of candidate design rules to retain further comprises, wherein no candidate planogram can be generated, outputting which design rules may be violated to allow the generation of at least one candidate planogram.

8. The at least one non-transitory computer-readable medium of claim 7 encoded with further instructions for determining a smallest subset of rules to relax such that one or more new candidate planograms are generated and the number of rules that are respected is maximized.

9. The at least one non-transitory computer-readable medium of claim 1 encoded with further instructions for exploring criteria, when a plurality of candidate planograms are available, to automatically select one of the candidate planograms.

10. The at least one non-transitory computer-readable medium of claim 9 wherein the criteria comprise at least two of minimizing differences between candidate and current planograms, maximizing differences between candidate and current planograms,
maximizing how many optional rules may be violated, minimizing how many optional rules may be violated, minimizing similarity of planogram changes across all affected stores, and maximizing similarity of planogram changes across all affected stores.

11. The at least one non-transitory computer-readable medium of claim 1 encoded with further instructions for receiving rule input utilizing historical data for a given store based upon store capacity data and store velocity data.

12. The at least one non-transitory computer-readable medium of claim 1 encoded with further instructions for clustering stores based upon (i) known customer attribute data for each of the clustered stores or (ii) store attributes.

13. A computing device comprising:
at least one memory; and
at least one processor coupled to at least one of the at least one memory, the at least one processor being configured to perform operations to:
generate a plurality of candidate planograms based upon a plurality of current design rules;
output a graphical representation of each of a subset comprising a plurality of the candidate planograms;
receive categorization input to place each candidate planogram in the subset within one of a plurality of categories;
create and outputting candidate rules based upon at least one of the categories;
receive rule input specifying a plurality of candidate design rules to retain;
output an updated subset of the candidate planograms based upon the received design rule input; and
output a graphical representation of at least one finalized planogram.

14. The computing device of claim 13, wherein generating a plurality of candidate planograms is further based upon one or more current planograms.

15. The computing device of claim 13, wherein generating a plurality of candidate planograms is further based upon at least one of:
rules that constrain physical layouts of products in a category;
physical dimensions of products in the category and structures where products are situated; and
recommended changes to assortments, planograms or in-store product locations and stores and product categories where these changes should be made.

16. The computing device of claim 15, wherein generating a plurality of candidate planograms is further based upon identification of which of the rules that can be violated.

17. The computing device of claim 13, wherein the at least one processor being configured to perform operations to receive final selection criteria, where the final selection criteria are utilized to determine the at least one finalized planogram.

18. A method comprising:
generating a plurality of candidate planograms based upon a plurality of current design rules;
outputting a graphical representation of each of a subset comprising a plurality of the candidate planograms;
receiving categorization input to place each candidate planogram in the subset within one of a plurality of categories;
creating and outputting candidate rules based upon at least one of the categories;
receiving rule input specifying a plurality of candidate design rules to retain;
outputting an updated subset of the candidate planograms based upon the received design rule input; and
outputting a graphical representation of at least one finalized planogram.

19. The method of claim 18 wherein generating a plurality of candidate planograms is further based upon one or more current planograms.

20. The method of claim 18 wherein generating a plurality of candidate planograms is further based upon at least one of:
rules that constrain physical layouts of products in a category;
physical dimensions of products in the category and structures where products are situated; and
recommended changes to assortments, planograms or in-store product locations and stores and product categories where these changes should be made.
